(19) United States
(12) Patent Application Publication
(10) Pub. No.: US 2005/0183727 A1
(43) Pub. Date: Aug. 25, 2005

(54) Mask having anti-virus and anti-germ effect

(76) Inventor: Su Jen Chou, Ho Mei Town (TW)

Correspondence Address: CHARLES E. BAXLEY, ESQ., 90 JOHN STREET, THIRD FLOOR, NEW YORK, NY, 10038, US

(21) Appl. No.: 10/785,357

(22) Filed: Feb. 23, 2004

(51) Int. Cl. A62B 18/02; A62B 7/10

(52) U.S. Cl. 128/206.19; 128/205.25; 128/205.29

(57) ABSTRACT

A mask includes an outer layer having a number of hair members to form a hairy structure and to be formed as a surfactant device to spoil surface tension of moist that are attached onto the hair members of the outer layer. An intermediate layer of active carbon materials is attached onto the outer layer, for absorbing odors, nervous or poisonous gases, and for filtering viruses, or germs. An inner layer of anti-moist cloth materials is attached onto the active carbon intermediate layer, for engaging with users, and for preventing the active carbon intermediate layer from contacting with the users. The layers are secured together to form an integral structure.

### BACKGROUND OF THE INVENTION

1. Field of the Invention

The present invention relates to a mask, and more particularly to a gauze mask having anti-virus and/or anti-germ structures or effects.

2. Description of the Prior Art

Typically, common cold, influenza, bronchitis, pulmonary tuberculosis, or other respiratory tract infectious diseases may be affected via flying froth. Various kinds of typical masks have been developed for being attached onto noses of users, to prevent the users from being affected by viruses, germs, or the like.

The typical masks are normally made of one or more layers of woven or non-woven clothes, and the other typical masks may include an additional active carbon layer disposed or engaged within the woven or non-woven clothes, for filtering viruses, germs, or the like.

However, the typical active carbon layers provided in the typical masks for filtering bad odors or the like. The typical active carbon layers normally comprise a number of macropores formed therein, such that the typical active carbon layers of the typical masks may not be used to effectively filter the viruses, the germs, or the like, and such that some of the viruses or the germs may also have a good chance to enter into the lungs of the users.

In addition, for some of the typical masks, the active carbon layers are directly contacted with the users, and some portions of the active carbon layers may have a good chance to be disengaged from the masks and may also have a good chance to enter into the lungs of the users, which is not good for the users.

The present invention has arisen to mitigate and/or obviate the afore-described disadvantages of the conventional masks.

### SUMMARY OF THE INVENTION

The primary objective of the present invention is to provide a mask including an anti-virus and/or anti-germ structure for suitably filtering viruses, germs, or the like, and for preventing the viruses or the germs from entering into the lungs of the users.

In accordance with one aspect of the invention, there is provided a mask comprising an outer layer including a plurality of hair members provided on outer peripheral portion thereof to form a hairy structure and to be formed as a surfactant device to spoil surface tension of moist that are attached onto the hair members of the outer layer, an intermediate layer of active carbon materials attached onto the outer layer, for absorbing odors, nervous or poisonous gases, and for filtering viruses, or germs, and an inner layer of anti-moist cloth materials attached onto the active carbon intermediate layer, for engaging with users, and for preventing the active carbon intermediate layer from contacting with the users. The inner layer and the active carbon intermediate layer and the outer covering layer may be secured together to form an integral structure, and to prevent the inner layer and the active carbon intermediate layer and the outer covering layer from being disengaged from each other.

The outer layer is treated with anti-virus and/or anti-germ medical materials, to increase an anti-virus and/or anti-germ effect of the outer layer.

The inner layer and the active carbon intermediate layer and the outer covering layer may be secured together with fibers, stitches, or by weaving processes, to prevent the layers from being disengaged from each other.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial cross sectional view of a mask in accordance with the present invention, illustrating an attachment of the mask onto a user;

FIG. 2 is a perspective view of the mask;

FIG. 3 is a partial exploded view of the mask;

FIG. 4 is an enlarged partial perspective view showing an outer layer of the mask;

FIG. 5 is another enlarged partial perspective view showing an anti-moist inner layer of the mask;

FIG. 6 is a further enlarged partial perspective view illustrating an interweaving structure of the mask;

FIGS. 7, 8 are front plan schematic views illustrating the operation of the mask;

FIG. 9 is a side plan schematic view illustrating the attachment of the mask onto the face of the user; and

FIG. 10 is an enlarged partial perspective view illustrating the operation of the mask.

### DETAILED DESCRIPTION OF THE PREFERRED EMBODIMENT

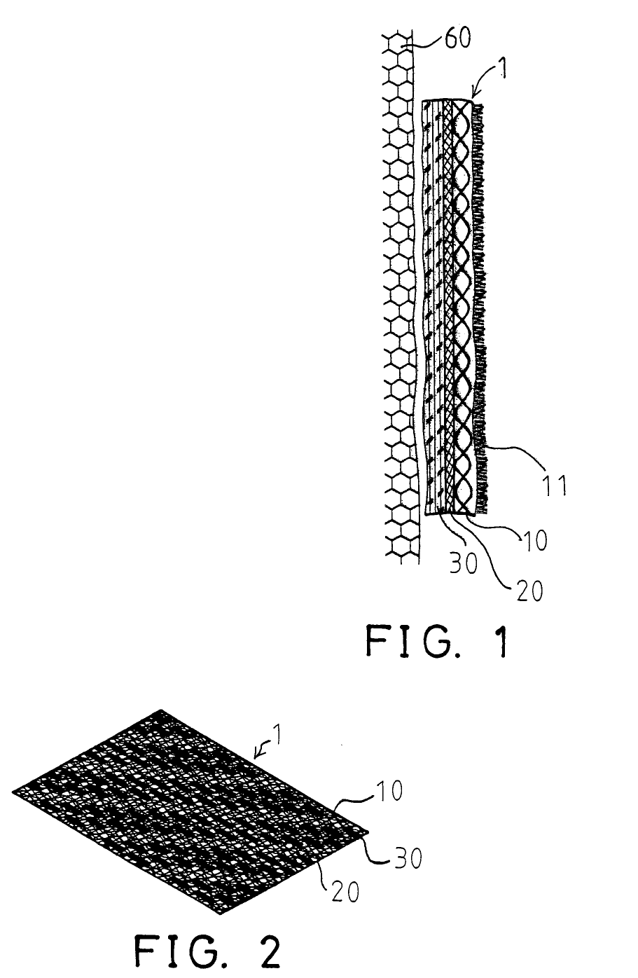

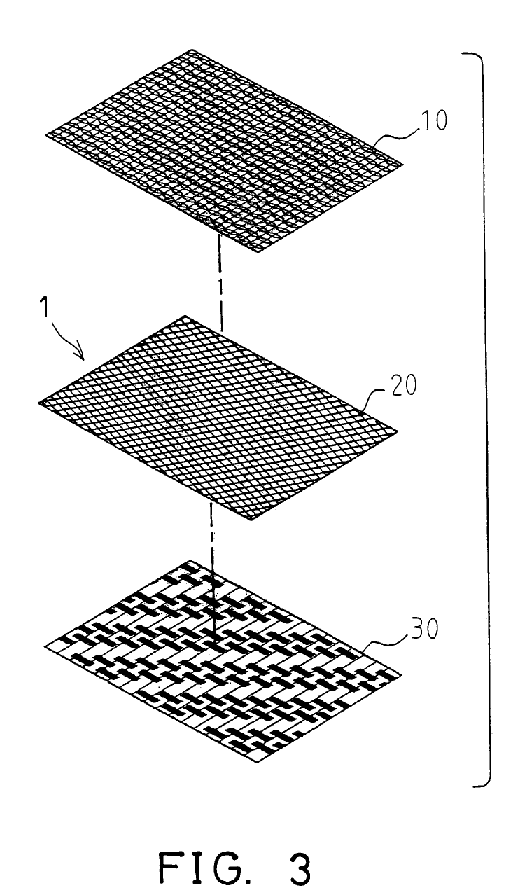

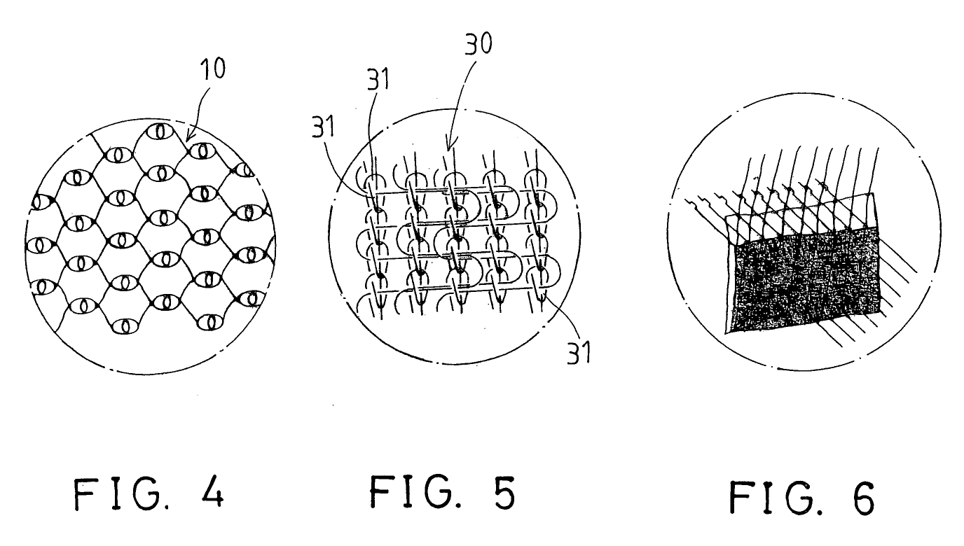

Referring to the drawings, and initially to FIGS. 1-4, a mask 1 in accordance with the present invention comprises an outer covering layer 10 made of one or more woven or non-woven clothes, an intermediate layer 20 of active carbon materials, and an anti-moist inner layer 30. The three layers 10, 20, 30 are secured together with fibers or stitches or the like or by weaving processes.

The outer layer 10 includes a number of fine hair members 11 formed or provided on the outer peripheral portion thereof (FIG. 1) for forming a hairy structure. The hair members 11 of the outer layer 10 may be formed as a surfactant device for spoiling or obstructing the surface tension of moist or fluid substances that are attached onto the hair members 11 of the outer layer 10, for allowing the moist or fluid substances to be easily absorbed into the outer layer 10.

It is preferable that the outer layer 10 is soaked or immersed within or treated with anti-virus and/or anti-germ medical materials, to increase the anti-virus and/or anti-germ effect of the outer layer 10. The outer layer 10 that is treated with anti-virus and/or anti-germ medical materials may have an anti-virus and/or anti-germ rate up to 99.99%; and may still have an anti-virus and/or anti-germ rate of more than 75% after the outer layer 10 has been washed for more than one hundred times.

The intermediate layer 20 of active carbon materials may also be made of one or more woven or non-woven clothes that are formed with fibers having the active carbon materials engaged or provided therein, for absorbing odors, floating organic materials, organic solutions, nervous or poisonous gases, or the like, and may include a number of micropores 31 formed therein (FIG. 5) for filtering viruses, germs, or the like.

The inner layer 30 is preferably made of anti-moist woven cloth materials, and is attached or secured onto the active carbon intermediate layer 20, for engaging with the users 60 (FIGS. 1 and 7-9), and for preventing the active carbon intermediate layer 20 from engaging or contacting with the users, and thus for preventing the active carbon materials from entering into the lungs of the users.

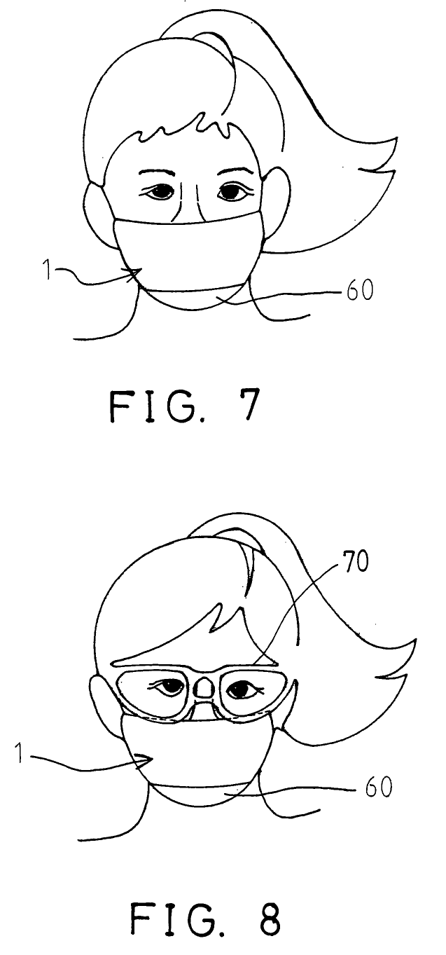

The inner layer 30 and the active carbon intermediate layer 20 and the outer covering layer 10 are preferably secured together with fibers or stitches or the like (FIG. 6), to form an integral structure, and to prevent the layers 10, 20, 30 from being disengaged from each other, and thus for allowing the mask 1 to be easily attached onto the face of the users 60 (FIG. 7). The attachment of the mask 1 onto the face of the users 60 will not affect the wearing of the eyeglasses 70 onto the face of the users 60 (FIG. 8).

In operation, the hair members 11 of the outer layer 10 may be used to spoil or obstruct the surface tension of moist or fluid substances that are attached onto the hair members 11 of the outer layer 10, for allowing the moist or fluid substances or froth 40 to be absorbed into the outer layer 10. In addition, the viruses, germs, or the like contained in the moist or froth 40 may be killed by the outer layer 10 that has been soaked or immersed within or treated with anti-virus and/or anti-germ medical materials.

The active carbon intermediate layer 20 may be used to absorb odors, nervous or poisonous gases, or filter viruses, germs, or the like. The anti-moist inner layer 30 is attached onto the active carbon intermediate layer 20, and is thus positioned between between the active carbon intermediate layer 20 and the users 60, to prevent the active carbon intermediate layer 20 from engaging or contacting with the users, and thus to prevent the active carbon materials from entering into the lungs of the users.

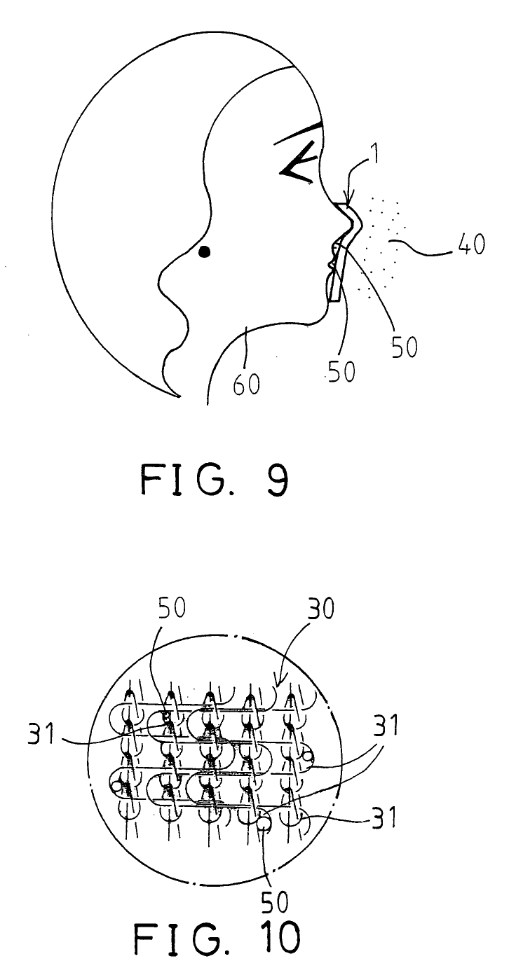

The anti-moist inner layer 30 may be used to absorb the moist 50 exhaled by the users (FIGS. 9, 10) with such as the micropores 31 of the anti-moist inner layer 30, and to allow the users to easily breathe. The anti-moist inner layer 30 is not soaked or immersed within or treated with anti-virus and/or anti-germ medical materials, to prevent the anti-virus and/or anti-germ medical materials from being inhaled or breathed into the lungs of the users.

Accordingly, the mask in accordance with the present invention includes an anti-virus and/or anti-germ structure for suitably filtering viruses, germs, or the like, and for preventing the viruses or the germs from entering into the lungs of the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A mask comprising:
an outer layer including a plurality of hair members provided on outer peripheral portion thereof to form a hairy structure and to be formed as a surfactant device to spoil surface tension of moist that are attached onto said hair members of said outer layer,
an intermediate layer of active carbon materials attached onto said outer layer, for absorbing odors, nervous or poisonous gases, and for filtering viruses, or germs, and
an inner layer of anti-moist cloth materials attached onto said active carbon intermediate layer, for engaging with users, and for preventing said active carbon intermediate layer from contacting with the users,
said inner layer and said active carbon intermediate layer and said outer covering layer being secured together to form an integral structure, and to prevent said inner layer and said active carbon intermediate layer and said outer covering layer from being disengaged from each other.

2. The mask as claimed in claim 1, wherein said outer layer is treated with anti-virus and/or anti-germ medical materials, to increase an anti-virus and/or anti-germ effect of said outer layer.

3. The mask as claimed in claim 1, wherein said inner layer and said active carbon intermediate layer and said outer covering layer are secured together with stitches.

4. The mask as claimed in claim 1, wherein said inner layer and said active carbon intermediate layer and said outer covering layer are secured together with weaving processes.
